(19) United States
(12) Patent Application Publication
(10) Pub. No.: US 2026/0133050 A1
(43) Pub. Date: May 14, 2026

(54) METHOD AND DEVICE FOR GENERATING A POSE GRAPH

(71) Applicant: URSROBOT AI INC., TAIPEI CITY (TW)

(72) Inventors: YU-HSIANG LAI, TAIPEI CITY (TW); SHIH-YU CHEN, TAIPEI CITY (TW); FENG-LI LIAN, TAIPEI CITY (TW); CHUNG-HOU WU, TAIPEI CITY (TW); CHAO-CHENG CHEN, TAIPEI CITY (TW)

(21) Appl. No.: 19/188,432

(22) Filed: Apr. 24, 2025

(30) Foreign Application Priority Data
Nov. 13, 2024 (TW) 113143522

(51) Int. Cl. G01C 21/00

(52) U.S. Cl. CPC G01C 21/3848

(57) ABSTRACT

A method for generating a pose graph is to be implemented by a device that includes a processing module, and a positioning module and a visual-inertial module that are electrically connected to the processing module. The method includes, by the processing module: executing a building procedure for generating an original pose graph; and optimizing the original pose graph to obtain an optimized pose graph based on a weight determined in the building procedure. The building procedure includes, by the processing module: generating a current node in the original pose graph in a current execution of the building procedure; determining an edge between the current node and a previous node in the original pose graph, the previous node being generated in a previous execution of the building procedure; and determining the weight for the edge between the current node and the previous node.

### CROSS-REFERENCE TO RELATED APPLICATION

This application claims priority to Taiwanese Invention Patent Application No. 113143522, filed on Nov. 13, 2024, the entire disclosure of which is incorporated by reference herein.

### FIELD

The disclosure relates to a method and a device for generating a pose graph.

### BACKGROUND

In the field of unmanned vehicles, in order for an unmanned vehicle to automatically traverse a target area, a major problem is to establish a repeatable movement path for the unmanned vehicle to traverse. A conventional method of establishing the repeatable movement path is to obtain sensing data related to the surrounding of the unmanned vehicle and a position of the unmanned vehicle respectively through a sensor module disposed in the unmanned vehicle and a positioning signal received by the unmanned vehicle, and to establish a pose graph that corresponds to the target area based on the sensing data and the position of the unmanned vehicle.

Due to the influence of various external environmental factors during movement of the unmanned vehicle, the sensing data or the positioning signal received by the unmanned vehicle may be inaccurate. For example, when the unmanned vehicle passes through an obstruction, the unmanned vehicle may receive an unstable positioning signal. This may lead to the unmanned vehicle constructing a node in the pose graph based on the unstable positioning signal, which may lead to an optimized result of the pose graph to be less accurate and unable to accurately represent the actual environment of the target area.

### SUMMARY

Therefore, an object of the disclosure is to provide a method and device for generating a pose graph that can alleviate at least one of the drawbacks of the prior art.

According to an aspect of the disclosure, the method is to be implemented by a device that includes a processing module, and a positioning module and a visual-inertial module that are electrically connected to the processing module. The positioning module is configured to receive a positioning signal that indicates a position of the device. The visual-inertial module is configured to generate a sensing data set that is related to a surrounding of the device and a motion state of the device. The method includes: the processing module executing a building procedure for generating an original pose graph, the building procedure including, in response to receipt of a current positioning signal from the positioning module and a current sensing data set from the visual-inertial module in a current execution of the building procedure, generating a current node in the original pose graph based on the current positioning signal and the current sensing data set, determining an edge between the current node and a previous node in the original pose graph based on the current sensing data set and a previous sensing data set that was received by the processing module in a previous execution of the building procedure immediately before the current execution of the building procedure, the previous node being generated based on the previous sensing data set and a previous positioning signal that was received by the processing module in the previous execution of the building procedure, and determining a weight for the edge between the current node and the previous node according to signal strength of the current positioning signal and signal strength of the previous positioning signal; and the processing module optimizing the original pose graph to obtain an optimized pose graph based on the weight determined in the building procedure.

According to another aspect of the disclosure, the device includes a processing module, and a positioning module and a visual-inertial module that are electrically connected to the processing module. The positioning module is configured to receive a positioning signal that indicates a position of the device. The visual-inertial module is configured to generate a sensing data set that is related to a surrounding of the device and a motion state of the device. The processing module is configured to execute a building procedure for generating an original pose graph. The building procedure includes: in response to receipt of a current positioning signal from the positioning module and a current sensing data set from the visual-inertial module in a current execution of the building procedure, generating a current node in the original pose graph based on the current positioning signal and the current sensing data set; determining an edge between the current node and a previous node in the original pose graph based on the current sensing data set and a previous sensing data set that was received by the processing module in a previous execution of the building procedure immediately before the current execution of the building procedure, the previous node being generated based on the previous sensing data set and a previous positioning signal that was received by the processing module in the previous execution of the building procedure; and determining a weight for the edge between the current node and the previous node according to signal strength of the current positioning signal and signal strength of the previous positioning signal. The processing module is further configured to optimize the original pose graph to obtain an optimized pose graph based on the weight determined in the building procedure.

### BRIEF DESCRIPTION OF THE DRAWINGS

Other features and advantages of the disclosure will become apparent in the following detailed description of the embodiment(s) with reference to the accompanying drawings. It is noted that various features May not be drawn to scale.

FIG. 1 is a block diagram of a device for generating a pose graph according to an embodiment of the disclosure.

FIG. 2 is a flow chart illustrating a method for generating a pose graph according to an embodiment of the disclosure.

FIG. 3 is a flow chart illustrating an optimizing procedure of the method according to an embodiment of the disclosure.

FIGS. 4 and 5 are schematic diagrams cooperatively illustrating a building procedure of the method for generating an original pose graph according to an embodiment of the disclosure.

FIGS. 6 and 7 are schematic diagrams cooperatively illustrating an optimizing procedure of the method for generating an intermediate pose graph based on the original pose graph according to an embodiment of the disclosure.

FIG. 8 is a schematic diagram illustrating the intermediate pose graph after optimization according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

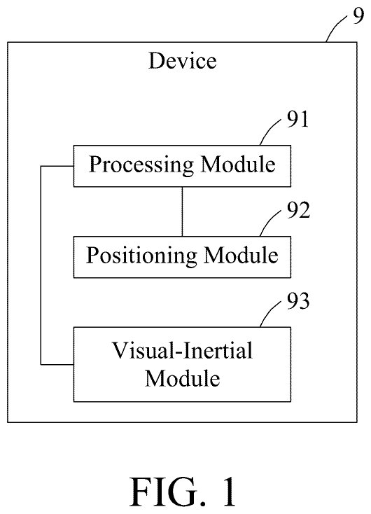

Referring to FIG. 1, a device 9 for generating a pose graph is provided according to an embodiment of this disclosure, and includes a processing module 91, and a positioning module 92 and a visual-inertial (VI) module 93 that are electrically connected to the processing module 91. The positioning module 92 is configured to receive a positioning signal that indicates a position of the device 9. The VI module 93 is configured to generate a sensing data set that is related to a surrounding of the device 9 and a motion state of the device 9. Specifically, the sensing data set includes image data that is related to an image of a scene of the surrounding of the device 9, and inertial data that is related to the motion state of the device 9.

In one embodiment, the device 9 is embodied by an autonomous vehicle or a mobile robot, but the disclosure is not limited to such.

The processing module 91 is exemplified as a central processing unit (CPU), a system-on-chip (SoC), or a microcontroller (MC). However, the disclosure is not limited to such.

The positioning module 92 is configured to use, for example, the real-time kinematic (RTK) positioning technique for determining the position of the device 9, but the disclosure is not limited to such.

The VI module 93 includes an inertial measurement unit (IMU) for obtaining the inertial data of the device 9, and an image sensor for obtaining the image data. The inertial data may include measurements of the acceleration, angular velocity, and orientation of the device 9, which together indicate the motion state (e.g., stationary, moving, or rotating) of the device 9. Specifically, the IMU may be embodied as a 3-axis IMU or a 6-axis IMU, but the disclosure is not limited to such. The image sensor may be embodied by a monocular camera or a stereo camera, but the disclosure is not limited to such.

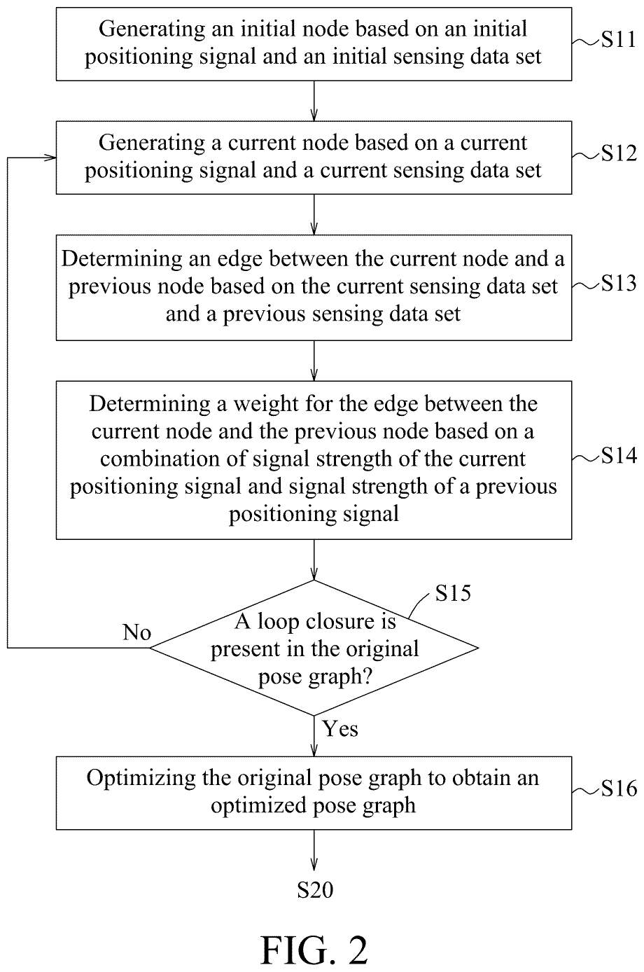

Referring to FIG. 2, a method for generating a pose graph according to an embodiment of the disclosure includes steps S11 to S16. For example, the method may be implemented by the device 9 of FIG. 1.

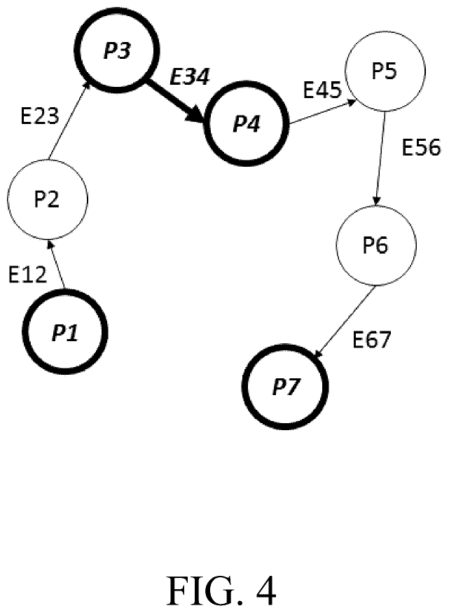

In step S11, the processing module 91, in response to receipt of an initial positioning signal from the positioning module 92 and an initial sensing data set from the VI module 93, generates an initial node that is denoted as “P1” in an initial pose graph (see FIG. 4) based on the initial positioning signal and the initial sensing data set. The initial node (P1) corresponds to an initial position of the device 9 when the device 9 is first placed in a target area.

After the processing module 91 has generated the initial node (P1), as the device 9 moves around the target area, the processing module 91 executes a building procedure that includes steps S12 to S15 for generating an original pose graph. In some embodiments, a manner in which the device 9 moves around the target area is predetermined by a user, but the disclosure is not limited to such.

It should be noted that, in executing the building procedure for a first time, the initial sensing data set, the initial positioning signal, the initial node, and the initial pose graph serve as a previous sensing data set, a previous positioning signal, a previous node, and the original pose graph, respectively.

In step S12, in response to receipt of a current positioning signal from the positioning module 92 and a current sensing data set from the VI module 93 in a current execution of the building procedure, the processing module 91 generates a current node in the original pose graph based on the current positioning signal and the current sensing data set. Referring to FIG. 4, when executing the building procedure for the first time, the current node that is currently generated by the processing module 91 is denoted as “P2”.

In step S13, the processing module 91 determines an edge between the current node and the previous node in the original pose graph based on the current sensing data set and the previous sensing data set. Referring to FIG. 4, the edge that is generated in executing the building procedure for the first time is represented as an arrow pointing from the previous node (P1) to the current node (P2).

In step S14, the processing module 91 determines a weight for the edge between the current node and the previous node according to signal strength of the current positioning signal and signal strength of the previous positioning signal. In FIG. 4, the weight that is generated in executing the building procedure for the first time is denoted as “E12”. For example, the processing module 91 is further configured to determine signal strength of each positioning signal according to a signal-to-noise ratio (SNR) or a carrier-to-noise density ratio (C/NO) of the positioning signal.

In this embodiment, the signal strength of each of the current positioning signal and the previous positioning signal is at a high strength level or at a low strength level. For example, when it is determined that the SNR or the C/NO of the positioning signal is greater than a predetermined threshold, the signal strength thereof is at the high strength level; otherwise, the signal strength is at the low strength level. The weight is determined based on a combination of the signal strength of the current positioning signal and the signal strength of the previous positioning signal. The combination is a first combination of the current positioning signal and the previous positioning signal both having the high strength level, a second combination of one of the current positioning signal and the previous positioning signal having the high strength level and another one of the current positioning signal and the previous positioning signal having the low strength level, or a third combination of the current positioning signal and the previous positioning signal both having the low strength level. For example, when executing the building procedure for the first time, the signal strength of the current positioning signal (i.e., associated with the current node (P2)) is at the low strength level, and the signal strength of the previous positioning signal (i.e., associated with previous node (P1)) is at the high strength level. That is to say, the weight for the edge between the previous node (P1) and the current node (P2) is determined based on the second combination of the signal strength of the current positioning signal and the signal strength of the previous positioning signal. In some embodiments, the weight is positively correlated with the combination of the signal strength of the current positioning signal and the signal strength of the previous positioning signal. For example, a weight that is determined based on the first combination of the signal strength is higher than a weight that is determined based on the second combination of the signal strength, and the weight that is determined based on the second combination of the signal strength is higher than a weight that is determined based on the third combination of the signal strength.

In step S15, the processing module 91 determines whether the original pose graph has a loop closure. When the processing module 91 determines that the original pose graph, up to this point in time, does not have a loop closure, the flow goes back to step S12 and the processing module 91 repeats the building procedure. The flow goes to step S16 when the determination is affirmative.

In some embodiments, the processing module 91 uses a loop closure detection procedure to determine the presence of a loop closure. The loop closure detection procedure includes the processing module 91 using, for example, a key point extraction algorithm such as a scale-invariant feature transform (SIFT) and a speeded up robust features (SURF) to analyze initial image data that is included in the initial sensing data set and that corresponds to a surrounding view of the device 9 at the initial position, so as to obtain initial feature data. In response to the processing module 91 receiving the current sensing data set, the processing module 91 uses the key point extraction algorithm on current image data corresponding to a surrounding view of the device 9 at a current position that is included in the current sensing data set, to obtain current feature data. Then, the processing module 91 determines whether a similarity score between the initial feature data and the current feature data is greater than a predetermined value. Specifically, in this embodiment, the processing module 91 utilizes a distributed bag of words (DBoW2) algorithm, which converts the initial feature data and the current feature data into a bag-of-words representation. The processing module 91 then determines the similarity score between the initial feature data and the current feature data based on a DBoW2 vocabulary model. If the similarity score is greater than the predetermined value, it means that a scene represented by the current feature data is the same or highly similar to a scene represented by the initial feature data. In this embodiment, the predetermined value is determined by the user.

The processing module 91, in response to determining that the similarity score between the initial feature data and the current feature data is greater than the predetermined value, determines that a loop closure is present in the original pose graph; in response to determining that the similarity score between the initial feature data and the current feature data is not greater than the predetermined value, the processing module 91 determines that a loop closure is not present in the original pose graph. In some embodiments, the processing module 91 may determine whether a loop closure is present by comparing point cloud data of the initial image data and point cloud data of the current image data, and the disclosure is not limited to such.

For example, the determination made in step S15 in executing the building procedure for the first time is negative, and the flow goes back to step S12. The following illustrates the building procedure that is executed by the processing module 91 for a second time. It should be noted that, for the second and subsequent executions of the building procedure, the current sensing data set, the current positioning signal, and the current node that are used in the previous execution of the building procedure serve as the previous sensing data set, the previous positioning signal, and the previous node in the current execution of the building procedure, respectively.

The following description takes the second execution as an example. In step S12, the processing module 91, in response to receipt of a current positioning signal from the positioning module 92 and a current sensing data set from the VI module 93 in a current execution (i.e., for the second time) of the building procedure, generates a current node in the original pose graph based on the current positioning signal and the current sensing data set. Referring to FIG. 4, at this point in time, the current node that is generated by the processing module 91 is denoted as “P3”.

In step S13, the processing module 91 then determines an edge between the current node (P3) and a previous node (P2) in the original pose graph based on the current sensing data set and a previous sensing data set that was received by the processing module 91 in a previous execution of the building procedure immediately before the current execution of the building procedure. The previous node (P2) was generated based on the previous sensing data set and a previous positioning signal that was received by the processing module 91 in the previous execution of the building procedure. Referring to FIG. 4, the edge that is generated is represented as an arrow pointing from the previous node (P2) to the current node (P3).

In step S14, the processing module 91 determines a weight for the edge between the current node (P3) and the previous node (P2) according to signal strength of the current positioning signal and the signal strength of the previous positioning signal.

In step S15, the processing module 91 determines whether the original pose graph, up to this point in time, has a loop closure.

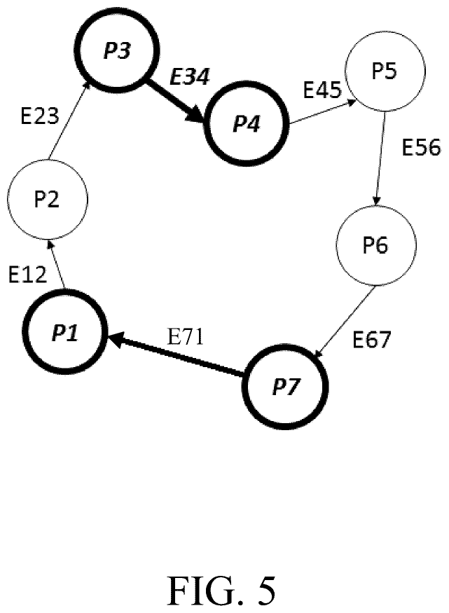

The processing module 91 may repeat the building procedure multiple times until a loop closure is determined to be present in the original pose graph. In this example, referring to FIG. 4, the processing module 91 determines that a loop closure is present in the last execution of the building procedure, in which a current node denoted by “P7” is generated, an edge between two nodes (P7, P6) denoted by an arrow from the node (P6) to the node (P7) is determined, and a weight denoted by “E67” for the edge between the two nodes (P7, P6) is determined. In response to the processing module 91 determining that a loop closure is present, the processing module 91 determines an edge (denoted by an arrow from the node (P7) to the node (P1) in FIG. 5) between the current node (P7) and the initial node (P1) in the original pose graph based on the current sensing data set and the initial sensing data set, and determines a weight (denoted by “E71” in FIG. 5) for the edge between the current node (P7) and the initial node (P1) according to the signal strength of the current positioning signal and the signal strength of the initial positioning signal. Since the signal strength of the current positioning signal (i.e., associated with the current node (P7) is at the high strength level, and the signal strength of the initial positioning signal (i.e., associated with the initial node (P1)) is at the high strength level. The weight for the edge between the current node (P7) and the initial node (P1) is determined based on the first combination of the signal strength of the current positioning signal and the signal strength of the initial positioning signal. The flow then goes to step S16.

In step S16, the processing module 91 optimizes the original pose graph to obtain an optimized pose graph based on the weights (e.g., E12, E23, E34, E45, E56, E67, and E71 as in FIG. 5) that are determined respectively in multiple executions of the building procedure. The optimized pose graph may be used by the autonomous vehicle or the mobile robot to perform automatic traversal in the target area following the optimized pose graph, but the disclosure is not limited to such.

In some embodiments, a way of optimizing the original pose graph includes using techniques such as non-linear least squares and bundle adjustment, but the disclosure is not limited to such. In this embodiment, for example, a general graph optimization (also known as g20) that is an open-source C++ framework for optimizing graph-based non-linear error functions is used to obtain the optimized pose graph, but this disclosure is not limited to such.

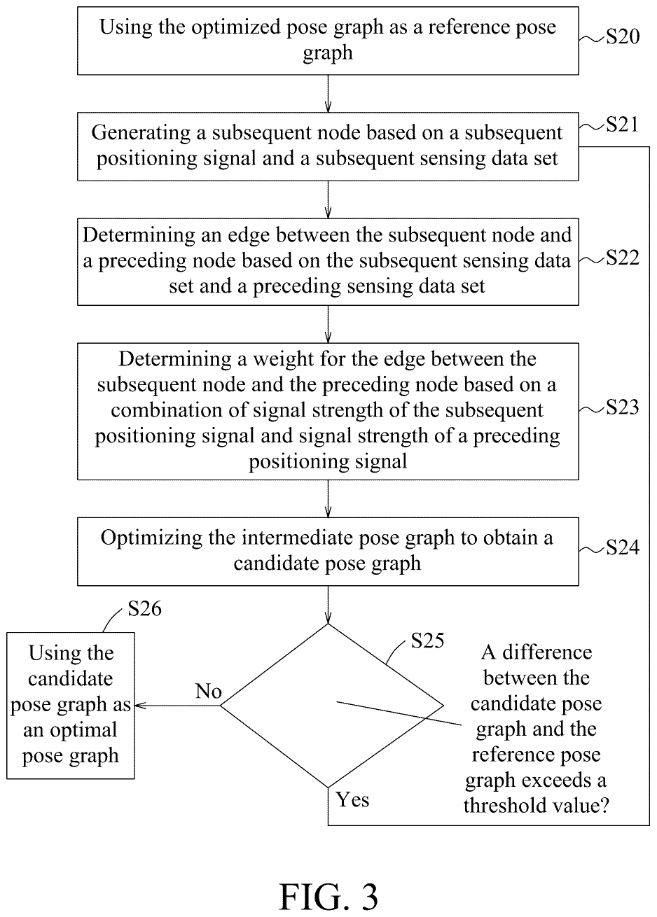

Referring to FIGS. 1 and 3, in some embodiments, the method includes the processing module 91 further optimizing the optimized pose graph. In such embodiments, the method further includes steps S20 to S26.

In step S20, continuing from the example above, the processing module 91 uses the optimized pose graph as a reference pose graph.

After step S20, the processing module 91 executes an optimizing procedure that includes steps S21 to S25. It should be noted that, when executing the optimizing procedure is executed for a first time, the current sensing data set received in the last execution of the building procedure, the current positioning signal received in the last execution of the building procedure and the current node (P7) generated in the last execution of the building procedure serve as a preceding sensing data set, a preceding positioning signal and a preceding node, respectively.

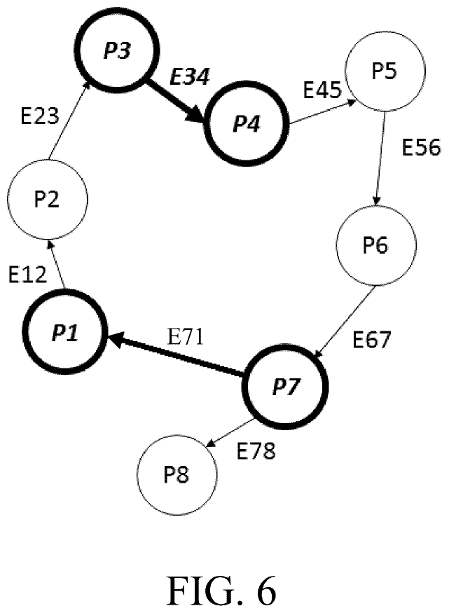

When the optimizing procedure is executed for the first time, in step S21, the processing module 91, in response to receipt of a subsequent positioning signal from the positioning module 92 and a subsequent sensing data set from the VI module 93, generates a subsequent node (denoted as “P8” in FIG. 6 in this example) in the reference pose graph to obtain an intermediate pose graph based on the subsequent positioning signal and the subsequent sensing data set. It should be noted that the subsequent positioning signal and the subsequent sensing data set are the latest positioning signal and sensing data set received by the processing module 91.

In step S22, the processing module 91 determines an edge between the subsequent node and the preceding node that was generated immediately before the subsequent node based on the subsequent sensing data set and the preceding sensing data set that was received by the processing module 91 immediately before the subsequent sensing data set. In this example, the edge is denoted as an arrow from the preceding node (P7) to the subsequent node (P8).

In step S23, the processing module 91 determines a weight for the edge between the subsequent node and the preceding node according to signal strength of the subsequent positioning signal and signal strength of the preceding positioning signal that was received immediately before the subsequent positioning signal. In some embodiments, the signal strength of each of the subsequent positioning signal and the preceding positioning signal is at the high strength level or the low strength level. The weight is determined based on a combination of the signal strength of the subsequent positioning signal and the signal strength of the preceding positioning signal. Similar to the building procedure, the combination is a first combination of the subsequent positioning signal and the preceding positioning signal both having the high strength level, a second combination of one of the subsequent positioning signal and the preceding positioning signal having the high strength level, and another one of the subsequent positioning signal and the preceding positioning signal having the low strength level, or a third combination of the subsequent positioning signal and the preceding positioning signal both having the low strength level. In such embodiments, the weight is positively correlated with the combination of the signal strength of the subsequent positioning signal and the signal strength of the preceding positioning signal. For example, a weight that is determined based on the first combination is higher than a weight that is determined based on the second combination. In this example, the weight for the edge between the subsequent node (P8) and the preceding node (P7) is determined according to the second combination of the signal strength of the subsequent positioning signal and the preceding positioning signal since the signal strength of the subsequent positioning signal (i.e., associated with the subsequent node (P8)) is at the low strength level, and the signal strength of the preceding positioning signal (i.e., associated with the preceding node (P7)) is at the high strength level, and the weight is denoted as “E78” in FIG. 6.

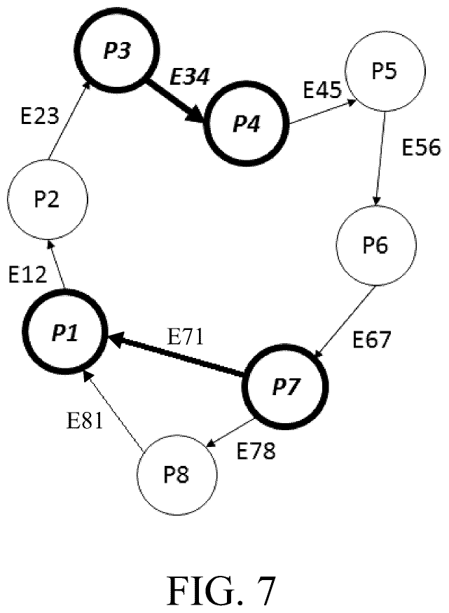

In some embodiments, after the processing module 91 has determined the weight for the edge between the subsequent node (P8) and the preceding node (P7), the processing module 91 further determines whether another loop closure related to the subsequent node (P8) is present in the intermediate pose graph. In response to the processing module 91 determining that another loop closure related to the subsequent node (P8) is present, the processing module 91 determines an edge (denoted by an arrow from the node (P8) to the node (P1) in FIG. 7) between the subsequent node (P8) and the initial node (P1) in the intermediate pose graph based on the subsequent sensing data set and the initial sensing data set, and determines a weight (denoted by “E81” in FIG. 7) for the edge between the subsequent node (P8) and the initial node (P1) according to the signal strength of the subsequent positioning signal and the signal strength of the initial positioning signal. Since the signal strength of the subsequent positioning signal (i.e., associated with the subsequent node (P8)) is at the low strength level, and the signal strength of the initial positioning signal (i.e., associated with the initial node (P1)) is at the high strength level. The weight for the edge between the subsequent node (P8) and the initial node (P1) is determined based on the second combination of the signal strength of the subsequent positioning signal and the signal strength of the initial positioning signal.

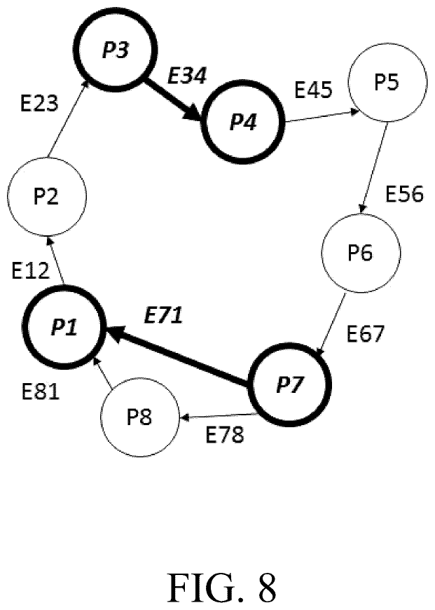

In step S24, the processing module 91 further optimizes the intermediate pose graph (FIG. 7) to obtain a candidate pose graph (FIG. 8) based on a plurality of weights including the weight of the edge between the subsequent node and the preceding node and all the weights determined in the building procedure. In some embodiments, the weights also include the weight that was determined in response to the processing module 91 determining that the another loop closure is present in the intermediate pose graph.

In step S25, the processing module 91 determines whether a difference between the candidate pose graph currently obtained in step S24 and the reference pose graph exceeds a threshold value. When the processing module 91 determines that the difference exceeds the threshold value, the flow goes back to step S21 and the processing module 91 repeats the optimizing procedure where the candidate pose graph, the subsequent node, the subsequent positioning signal and the subsequent sensing data set that were used in a previous execution of the optimizing procedure serve respectively as the reference pose graph, the preceding node, the preceding positioning signal and the preceding sensing data set in a subsequent execution of the optimizing procedure that is immediately after the previous execution of the optimizing procedure. The flow goes to step S26 and the optimizing procedure terminates when the determination is negative.

In this embodiment, since a pose graph that is optimized represents a minimization of an objective function, the candidate pose graph corresponds to a current objective function value, while the reference pose graph corresponds to a previous objective function value. When the difference between the current objective function value and the previous objective function value is less than the threshold value, the processing module 91 determines that the candidate pose graph and the reference pose graph has converged. In this embodiment, the threshold value is determined by the user.

In step S26, the processing module 91 uses the candidate pose graph as an optimal pose graph. The optimal pose graph may be used by the autonomous vehicle or the mobile robot to perform automatic traversal in the target area following the optimal pose graph, but the disclosure is not limited to such.

Referring to FIGS. 7 and 8, the intermediate pose graph after the processing module 91 has determined that another loop closure is present in the intermediate pose graph in step S23 according to this example, and the candidate pose graph obtained in step S24 according to this example are presented. In this example, nodes (P1) to (P8) are generated, and weights respectively for edges connecting the nodes (P1) to (P8) are labeled E12, E23, E34, E45, E56, E67, E78, E71 and E81. In FIG. 7, an orientation of the device 9 is not depicted in the intermediate pose graph for the sake of brevity, and only the connections (i.e., the edges) between every adjacent two of the nodes (P1) to (P8) are depicted. In this example, the positioning signals related respectively to the nodes (P1, P3, P4, P7) have the high strength level, and the positioning signals related respectively to the nodes (P2, P5, P6, P8) have the low strength level.

Table 1 below shows initial positions respectively of the nodes (P1) to (P8) in the intermediate pose graph shown in FIG. 7 (i.e., the nodes of the intermediate pose graph generated in the building procedure and the optimizing procedure), first optimized positions respectively of the nodes (P1) to (P8), second optimized positions respectively of the nodes (P1) to (P8), and values of the weights (E12, E23, E34, E45, E56, E67, E78, E71 and E81) respectively for edges connecting the nodes (P1) to (P8). The first optimized positions are obtained by optimizing the intermediate pose graph with a conventional method in which the weights of the edges connecting the nodes (P1) to (P8) are not taken into consideration, while the second optimized positions are obtained by optimizing the intermediate pose graph with the method of this disclosure (i.e., the candidate pose graph obtained in step S24). In this embodiment, each of the positions of the nodes (P1) to (P8) is expressed by a set of coordinates; the weight for each of the edges is given a value of, for example, 25 for an edge that is of the first combination of the signal strength, 5 for an edge that is of the second combination of the signal strength, and 1 for an edge that is of the third combination of the signal strength. When the weights respectively for the edges connecting the nodes (P1) to (P8) are not taken into consideration in optimizing the intermediate pose graph by a conventional method, the positions of the nodes (P2) to (P8) are changed after optimizing the intermediate pose graph (i.e. for each of the nodes (P2) to (P8), the first optimized position is different from the initial position). When the weights respectively for the edges connecting the nodes (P1) to (P8) are taken into consideration in optimizing the intermediate pose graph by the method of this disclosure, it can be seen that, since the weight of the edge between the nodes (P3) and (P4) is 25, and the weight of the edge between the nodes (P7) and (P1) is also 25 (i.e., the first combination of the signal strength), positions respectively of the nodes (P3), (P4), (P7) and (P1) do not change after optimizing the intermediate pose graph (i.e., for each of the nodes (P3), (P4), (P7) and (P1), the initial position is the same as the second optimized position). That is to say, since signal strength of the positioning signals related respectively to the nodes (P3), (P4), (P7) and (P1) are at the high strength level, and each of the nodes (P3), (P4), (P7) and (P1) has the edge that has the weight of 25, each of the nodes (P3), (P4), (P7) and (P1) is considered to be credible. During the optimization of the intermediate pose graph by the method of this disclosure, only the nodes (P2), (P5), (P6), and (P8) that are not credible will be adjusted causing positions of the nodes (P2), (P5), (P6), and (P8) to change.

TABLE 1

| | | First | Second | |
|---|---|---|---|---|
| | Initial | optimized | optimized | |
| | position | position | position | Weight |
| P1 | (0, 0) | (0, 0) | (0, 0) | E12: 5 |
| P2 | (−0.2, 1.5) | (−0.3, 1.5) | (−0.3, 1.4) | E23: 5 |
| P3 | (0.6, 2.8) | (0.5, 2.9) | (0.6, 2.8) | E34: 25 |
| P4 | (1.8, 2.2) | (1.6, 2.7) | (1.8, 2.2) | E45: 5 |
| P5 | (3.3, 2.6) | (3.0, 2.6) | (3.6, 2.4) | E56: 1 |
| P6 | (3.2, 0.9) | (3.0, 1.1) | (3.0, 0.7) | E67: 5 |
| P7 | (2.3, −0.5) | (2.2, −0.3) | (2.3, −0.5) | E78: 5 |
| | | | | E71: 25 |
| P8 | (1.2, −1.4) | (0.7, −0.8) | (0.8, −0.9) | E81: 5 |

In sum, the processing module 91 optimizes the original pose graph based on the weights that are determined respectively in multiple executions of the building procedure, and each of the weights is determined according to signal strength of a current positioning signal and signal strength of a previous positioning signal during each execution of the building procedure. By virtue of the above arrangements, the processing module 91 is able to obtain the optimized pose graph and/or the optimal pose graph for the target area, where the nodes that are generated based on positioning signals having the high strength level are less likely to be changed compared to other nodes that are generated based on positioning signals having the low strength level, thereby weakening influence of said other nodes when the processing module 91 is optimizing the original pose graph or the intermediate pose graph.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for generating a pose graph to be implemented by a device that includes a processing module, a positioning module electrically connected to the processing module and configured to receive a positioning signal that indicates a position of the device, and a visual-inertial module electrically connected to the processing module and configured to generate a sensing data set that is related to a surrounding of the device and a motion state of the device, said method comprising:
the processing module executing a building procedure for generating an original pose graph, the building procedure including
in response to receipt of a current positioning signal from the positioning module and a current sensing data set from the visual-inertial module in a current execution of the building procedure, generating a current node in the original pose graph based on the current positioning signal and the current sensing data set,
determining an edge between the current node and a previous node in the original pose graph based on the current sensing data set and a previous sensing data set that was received by the processing module in a previous execution of the building procedure immediately before the current execution of the building procedure, the previous node being generated based on the previous sensing data set and a previous positioning signal that was received by the processing module in the previous execution of the building procedure, and
determining a weight for the edge between the current node and the previous node according to signal strength of the current positioning signal and signal strength of the previous positioning signal; and
the processing module optimizing the original pose graph to obtain an optimized pose graph based on the weight determined in the building procedure.

2. The method as claimed in claim 1, wherein the building procedure further includes:
determining whether the original pose graph has a loop closure; and
in response to determining that the original pose graph does not have a loop closure, repeating the building procedure,
wherein optimizing the original pose graph is executed in response to determining that the original pose graph has a loop closure, and is based on the weights that are determined respectively in multiple executions of the building procedure.

3. The method as claimed in claim 2, further comprising, after optimizing the original pose graph:
the processing module using the optimized pose graph as a reference pose graph; and
the processing module executing an optimizing procedure that includes:
in response to receipt of a subsequent positioning signal from the positioning module and a subsequent sensing data set from the visual-inertial module that are currently received by the processing module, generating a subsequent node in the reference pose graph to obtain an intermediate pose graph based on the subsequent positioning signal and the subsequent sensing data set,
based on the subsequent sensing data set and a preceding sensing data set that was received by the processing module immediately before the subsequent sensing data set, determining an edge between the subsequent node and a preceding node that was generated immediately before the subsequent node,
determining a weight for the edge between the subsequent node and the preceding node according to signal strength of the subsequent positioning signal and signal strength of a preceding positioning signal that was received immediately before the subsequent positioning signal,
further optimizing the intermediate pose graph to obtain a candidate pose graph based on a plurality of weights including the weight of the edge between the subsequent node and the preceding node and the weights determined in the building procedure,
determining whether a difference between the candidate pose graph obtained and the reference pose graph exceeds a threshold value, and
in response to determining that the difference does not exceed the threshold value, the processing module using the candidate pose graph as an optimal pose graph.

4. The method as claimed in claim 3, wherein the optimizing procedure further includes:
in response to determining that the difference exceeds the threshold value, repeating the optimizing procedure where the candidate pose graph, the subsequent node, the subsequent positioning signal and the subsequent sensing data set that were used in a previous execution of the optimizing procedure serve respectively as the reference pose graph, the preceding node, the preceding positioning signal and the preceding sensing data set in a subsequent execution of the optimizing procedure that is immediately after the previous execution of the optimizing procedure.

5. The method as claimed in claim 4, wherein the signal strength of each of the current positioning signal and the previous positioning signal is at one of a high strength level and a low strength level.

6. The method as claimed in claim 5, wherein, in determining the weight for the edge between the current node and the previous node, the weight is determined based on a combination of the signal strength of the current positioning signal and the signal strength of the previous positioning signal,
wherein the combination is one of
a first combination of the current positioning signal and the previous positioning signal both having the high strength level,
a second combination of one of the current positioning signal and the previous positioning signal having the high strength level, and another one of the current positioning signal and the previous positioning signal having the low strength level, and
a third combination of the current positioning signal and the previous positioning signal both having the low strength level.

7. The method as claimed in claim 3, wherein, in executing the optimizing procedure for a first time, the current sensing data set received in the last execution of the building procedure, the current positioning signal received in the last execution of the building procedure, and the current node generated in the last execution of the building procedure serve as the preceding sensing data set, the preceding positioning signal and the preceding node, respectively.

8. The method as claimed in claim 1, wherein the signal strength of each of the current positioning signal and the previous positioning signal is at one of a high strength level and a low strength level.

9. The method as claimed in claim 8, wherein, in determining the weight for the edge between the current node and the previous node, the weight is determined based on a combination of the signal strength of the current positioning signal and the signal strength of the previous positioning signal,
wherein the combination is one of
a first combination of the current positioning signal and the previous positioning signal both having the high strength level,
a second combination of one of the current positioning signal and the previous positioning signal having the high strength level, and another one of the current positioning signal and the previous positioning signal having the low strength level, and
a third combination of the current positioning signal and the previous positioning signal both having the low strength level.

10. A device for generating a pose graph, comprising:
a processing module;
a positioning module electrically connected to said processing module and configured to receive a positioning signal that indicates a position of said device; and
a visual-inertial module electrically connected to said processing module and configured to generate a sensing data set that is related to a surrounding of said device and a motion state of said device,
wherein said processing module is configured to execute a building procedure for generating an original pose graph, the building procedure including
in response to receipt of a current positioning signal from said positioning module and a current sensing data set from said visual-inertial module in a current execution of the building procedure, generating a current node in the original pose graph based on the current positioning signal and the current sensing data set,
determining an edge between the current node and a previous node in the original pose graph based on the current sensing data set and a previous sensing data set that was received by said processing module in a previous execution of the building procedure, the previous node being generated based on the previous sensing data set and a previous positioning signal that was received by said processing module in the previous execution of the building procedure, and
determining a weight for the edge between the current node and the previous node according to signal strength of the current positioning signal and signal strength of the previous positioning signal,
wherein said processing module is further configured to optimize the original pose graph to obtain an optimized pose graph based on the weight determined in the building procedure.

11. The device as claimed in claim 10, wherein the building procedure further includes:
determining whether the original pose graph has a loop closure; and
in response to determining that the original pose graph does not have a loop closure, repeating the building procedure,
wherein said processing module is configured to, in response to determining that the original pose graph has a loop closure, optimize the original pose graph based on the weights that are determined respectively in multiple executions of the building procedure.

12. The device as claimed in claim 11, wherein said processing module is further configured to, after optimizing the original pose graph:
use the optimized pose graph as a reference pose graph; and
execute an optimizing procedure that includes
in response to receipt of a subsequent positioning signal from said positioning module and a subsequent sensing data set from said visual-inertial module that are currently received by said processing module, generating a subsequent node in the reference pose graph to obtain an intermediate pose graph based on the subsequent positioning signal and the subsequent sensing data set,
based on the subsequent sensing data set and a preceding sensing data set that was received by said processing module immediately before the subsequent sensing data set, determining an edge between the subsequent node and a preceding node that was generated immediately before the subsequent node,
determining a weight for the edge between the subsequent node and the preceding node according to signal strength of the subsequent positioning signal and signal strength of a preceding positioning signal that was received immediately before the subsequent positioning signal,
further optimizing the intermediate pose graph to obtain a candidate pose graph based on a plurality of weights including the weight of the edge between the subsequent node and the preceding node and the weights determined in the building procedure,
determining whether a difference between the candidate pose graph obtained and the reference pose graph exceeds a threshold value, and
in response to determining that the difference does not exceed the threshold value, using the candidate pose graph as an optimal pose graph.

13. The device as claimed in claim 12, wherein the optimizing procedure further includes:
in response to determining that the difference exceeds the threshold value, repeating the optimizing procedure where the candidate pose graph, the subsequent node, the subsequent positioning signal and the subsequent sensing data set that were used in a previous execution of the optimizing procedure serve respectively as the reference pose graph, the preceding node, the preceding positioning signal and the preceding sensing data set in a subsequent execution of the optimizing procedure that is immediately after the previous execution of the optimizing procedure.

14. The device as claimed in claim 13, wherein the signal strength of each of the current positioning signal and the previous positioning signal is at one of a high strength level and a low strength level.

15. The device as claimed in claim 14, wherein, in determining the weight for the edge between the current node and the previous node, the weight is determined based on a combination of the signal strength of the current positioning signal and the signal strength of the previous positioning signal,
wherein the combination is one of
a first combination of the current positioning signal and the previous positioning signal both having the high strength level,
a second combination of one of the current positioning signal and the previous positioning signal having the high strength level, and another one of the current positioning signal and the previous positioning signal having the low strength level, and
a third combination of the current positioning signal and the previous positioning signal both having the low strength level.

16. The device as claimed in claim 12, wherein, in executing the optimizing procedure for a first time, the current sensing data set received in the last execution of the building procedure, the current positioning signal received in the last execution of the building procedure, and the current node generated in the last execution of the building procedure serve as the preceding sensing data set, the preceding positioning signal and the preceding node, respectively.

17. The device as claimed in claim 10, wherein the signal strength of each of the current positioning signal and the previous positioning signal is one of a high strength level and a low strength level.

18. The device as claimed in claim 17, wherein, in determining the weight for the edge between the current node and the previous node, the weight is determined based on a combination of the signal strength of the current positioning signal and the signal strength of the previous positioning signal,
wherein the combination is one of
a first combination of the current positioning signal and the previous positioning signal both having the high strength level,
a second combination of one of the current positioning signal and the previous positioning signal having the high strength level, and another one of the current positioning signal and the previous positioning signal having the low strength level, and
a third combination of the current positioning signal and the previous positioning signal both having the low strength level.
